(19) United States
(12) Patent Application Publication
(10) Pub. No.: US 2006/0218630 A1
(43) Pub. Date: Sep. 28, 2006

(54) Opt-in linking to a single sign-on account

(75) Inventors: Larry B. Pearson, San Antonio, TX (US); James M. Doherty, Georgetown, TX (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/087,360

(22) Filed: Mar. 23, 2005

(51) Int. Cl. G06F 17/30

(52) U.S. Cl. 726/8

(57) ABSTRACT

A system and method for providing a portal view of a trusted application to a user over a communication network is discussed. The portal view can be generated from at least one of the services linked to the application according to a trust model in which trust is extended to the application from the user. When the application provides single sign-on capabilities, those services that are linked to the application can then be logged into simultaneously when the user logs into only one of the services. The trusted application is opaque to those services not linked to the application. The portal view provides a means for linking and de-linking services.

### BACKGROUND OF THE INVENTION

1. Field of the Invention

The present invention relates to a method and apparatus for securely accessing data over multiple connection service providers in a communication network. In particular, the present invention provides a method and apparatus for opt-in linking of services to a single sign-on account in a network of service providers.

2. Description of the Related Art

With the growth of the Internet and the proliferation of services that are provided over the Internet, end-users, such as web users and web customers, have begun to accumulate multiple usernames and passwords for authenticating their access to these many services. Along with the increased number of usernames and passwords comes the problem of keeping track of them. If a given service is used infrequently, the associated username and password can slip the memory. On the other hand, the tendency of end-users to keep a written record lying around on a desk or computer monitor leaves one open to the possibility of security breaches.

Identity theft has become a significant threat to the growth of electronic commerce. Cases of misuse of online accounts by imposters as well as creation of new accounts using stolen identity and attribute information are prevalent. The resulting press accounts have served to dampen citizen, corporate, and government enthusiasm for electronic interactions which are sensitive or have monetary value.

One solution that is becoming available to consumers and businesses is federated identity management, that is, the ability to use or leverage information stored with one online commercial entity to conduct business with another online commercial entity. The Liberty Alliance Project is an alliance of companies and organizations for developing an open standard for federated network identity that supports all current and emerging network devices and developing standards for federated identity management which emphasize security and support the privacy of users in a networked world. The Liberty Alliance Project is well known in the art and documented, e.g. at www.projectliberty.org.

Within the Liberty model, an Identity Provider (IDP) is a trusted system (owned and operated by a third party or by the party providing services) that will hold some personal details of a Principal, such as an end-user or consumer. A separate Service Provider (SP), such as another company you the Principal may deal with, generally needs some of the data held by the IDP. An Opaque Identifier is used to perform this communication. The Opaque identifier is a machine-to-machine reference used by SP and IDP only when they exchange data of the Principal.

Global single sign-on (SSO) is the ability to go to a single site, log on and from there securely access multiple accounts at disparate sites (each with its own account and authentication structure). Global SSO is a key feature of the Liberty Alliance protocols. Global SSO allows the Principal to rely upon a single, secure password rather than use a separate password at each site.

The Liberty model, in its use of an opaque identifier, provides a built-in partial protection from identity theft or fraud. With the Liberty model federation, the IDP and SP together establish the opaque identifier(s) to be used to refer to a particular Principal. Subsequent SSO communications between the IDP and SP use this agreed-upon pseudonym for the Principal. In addition to requiring that it be presented with a ‘valid’ opaque identifier (i.e. one previously established with the IDP purportedly presenting it) the SP bases its trust in the IDP's SSO assertion through signatures, certificate chains, validity intervals and other technical mechanisms. The credentials are transient and limited to a specific domain, and the opaque identifier is valid only between these two companies thereby discouraging identity fraud if stolen. That is, the opaque identifier is a secret shared by the IDP and SP only. No other SP's use the same opaque identifier for the principal.

### SUMMARY OF THE INVENTION

The present invention provides a method and apparatus for linking a single sign-on (SSO) account with a service comprising establishing a SSO account, accepting a user selection for a service to link with the SSO account, and linking the selected service to link an SSO account. In one aspect of the invention, one or all of the services can generate a view of services linked with the SSO account from a service. A user can also select a service to de-link from the SSO account. The view generated can be a dynamic portal view comprising a web page. In another aspect of the invention a set of application program interfaces are presented embodied on a computer readable medium for execution on a computer in conjunction with an application program that links a single sign-on (SSO) account with a service comprising a first interface that receives a user input for establishing a SSO account, and a second interface that receives a user selection for a service to link with the SSO account, wherein the application program links the selected service to link with the SSO account.

The portal view of the application generally provides a menu of services available for opt-in linking to the application, a menu of services currently linked to the application, a method for linking services, and a method for de-linking services. As an example of linking a service, a service can be selected from the menu of available services. Selection can be performed by, for example, clicking a mouse pointer on an icon or hyperlink corresponding to the service on a web page. A web page is displayed in which the user enters the username and password. Upon submitting username and password, the selected service is linked to the application, and an icon or hyperlink corresponding to the linked service appears in a web page menu of linked applications.

A service can be de-linked from the application by an appropriate mechanism, such as clicking on an “X” icon displayed with the service's icon or hyperlink. Services can thus be linked and de-linked from the application. Login credentials for those services linked to the application are stored in a database. The dynamic linking of services is displayed in the portal view. If a service is entrusted to the application, a user can select the landing page (home page) of the service from the web portal by clicking on a hyperlink. Upon logging on to a linked service, data for generating the portal view is passed to the service. Therefore, the portal view can be generated from the service on which the user is presently logged on.

### BRIEF DESCRIPTION OF THE DRAWINGS

For a detailed understanding of the present invention, references should be made to the following detailed description of an exemplary embodiment, taken in conjunction with the accompanying drawings, in which like elements have been given like numerals.

FIG. 1 illustrates a federated identity model for associating services in a communication network;

FIG. 2 illustrates a ladder diagram of login using federated identity model;

FIG. 3 illustrates a web trust model for associating services in a communication network;

FIG. 4 illustrates a ladder diagram of login using the web trust model;

FIG. 5 illustrates an exemplary model for extending trust to a single sign-on application in the present example of the invention;

FIG. 6 illustrates a web page with links to services associated with single sign-on in the present example of the invention;

FIG. 7 illustrates a method for end-users to link their single sign-on account to a service in the present example of the invention;

FIG. 8 illustrates a web page through which a user can perform a local login to a service in the present example of the invention;

FIG. 9 illustrates a web portal login page in the present example of the invention;

FIG. 10 illustrates an exemplary landing page associated with single sign-on in the present example of the invention;

FIG. 11 illustrates a portal view for linking to a service in the present example of the invention;

FIG. 12 illustrates a web view of the process of linking a service in the present example of the invention;

FIG. 13 illustrates a portal view of a single sign-on application with one service linked to the application in the present example of the invention;

FIG. 14 illustrates a typical landing page of a service accessible through single sign-on in the present example of the invention;

FIG. 15 illustrates a system comprising a portal for initiating a federated Single Sign-On account linking an Identity Provider and a Service Provider; and

FIGS. 16 and 17 illustrate a ladder diagram for logging in using the federated SSO method of the present invention.

### DETAILED DESCRIPTION OF THE INVENTION

In view of the above, the present invention through one or more of its various aspects and/or embodiments is presented to provide one or more advantages, such as those noted below.

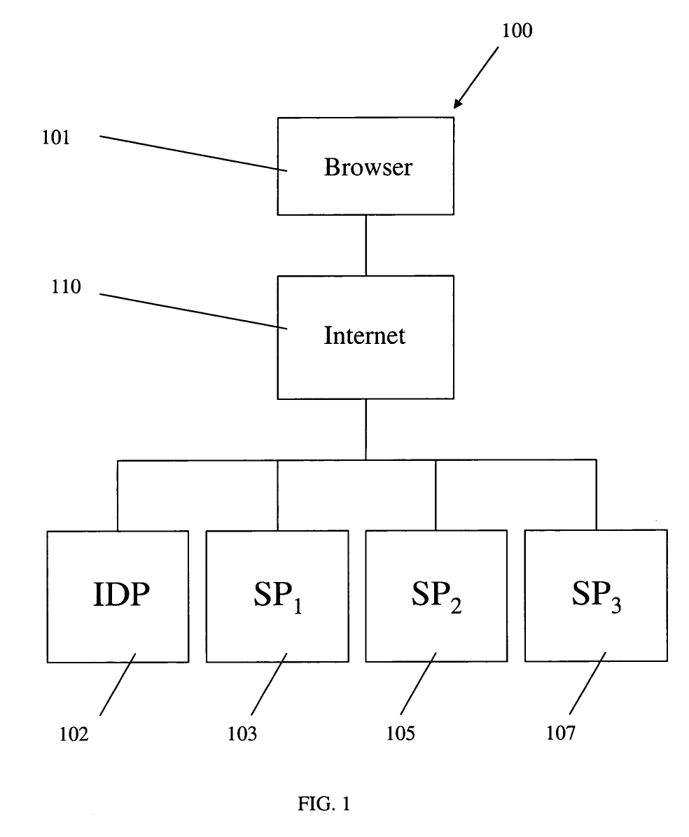

FIG. 1 illustrates a model 100 for associating services known as Federated Identity. Federated Identity comprises multiple service providers and multiple services operating on the service providers. A federated identity is a user identity and its associated entitlements that can be used across autonomous domains or business boundaries. Identity federation is based upon linking a user's otherwise distinct identities at two or more locations.

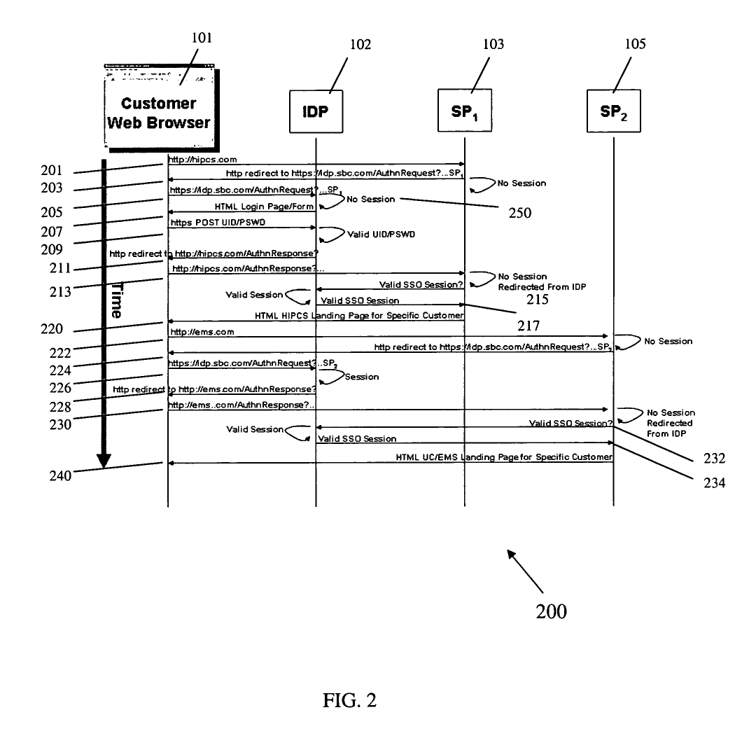

FIG. 1 comprises an Identity Provider (IDP) 102 and three service providers (SP₁ 103, SP₂ 105, and SP₃ 107) connected via the Internet to a web browser 101. Each service provider provides separate services, however it is possible to have multiples services provided by one service provider. A customer accesses these service providers from web browser 101 through Internet connection 110. Any number of service providers can be connected using this model, however, only three service providers are shown for illustrative purposes only. Operation of the Federated Identity model of FIG. 1 can be understood in reference to FIG. 2.

FIG. 2 illustrates a ladder diagram 200 displaying a time sequence of events from the web browser's (end-user) viewpoint 101 wherein a customer uses federated identity SSO to access SP applications. Service providers SP₁ 103 and SP₂ 105 and IDP 102 are shown for illustrative purposes. The sequence of steps is shown with time increasing down the page. At 201, the end-user directs browser 101 to the Uniform Resource Locator (URL) address of SP₁ 103 in order to access a web application located therein. At 203, the application of SP₁, noting that the end-user does not have an application session for SP₁, bounces (redirects) the customer browser over to the Identity Provider (IDP) 102. This is done by sending a redirect URL back to the browser 101. Encoded in the redirect URL is a message to the IDP notifying the IDP of a request for authentication from the application of SP₁. Therefore, at 205, the customer sees the URL displayed in his browser change from that of SP, 103 to the URL of the IDP 102. Behind the scenes, when the request reaches the IDP, the IDP checks to see if there is a current IDP login session for this particular browser at 207. Session management is not shown or described in detail, however, all ladder diagrams assume that session management is performed using cookies, which are well known in the art. A cookie is a piece of text that a web server can store on a user's hard disk. Cookies allow a web site to store information on a user's machine and later retrieve it. The pieces of information are stored as name-value pairs. For example, a web site might generate a unique ID number for each visitor and store the ID number on each user's machine using a cookie file.

In the illustration shown, there is no current login session, so the IDP web server sends a Hypertext Markup Language (HTML) login form back to the browser. The end-user receives the IDP login page (login form) at 207. The end-user fills in his username (user ID) and password and clicks on submit. The submitted login form is posted (POST) to the IDP web site (209). At 211, the IDP web site validates the username and password supplied in the POST. At 213, after the end-user has been validated (logged in), the end-user is redirected from the IDP back to the application of SP₁. The IDP knows which service provider to redirect the end-user back to from information received during step 203 above. The IDP encodes information on the URL to inform SP₁ that the login request has been validated and sends an artifact telling SP₁ how to validate the browser transmitted login request directly with the IDP 102. The application of SP₁ sees from the Hypertext Transfer Protocol (HTTP) information that the end-user has been redirected from the IDP. The application of SP₁ decodes the encoded URL information. Behind the scenes, the SP₁ application (SP₁) opens a back channel to the IDP to validate that the customer is a valid customer (215). The customer is valid and notification is returned to SP₁ (217). At 220, the application of SP₁ responds with the landing page for the specific customer account. A link to the second web site (SP₂) is on the landing page of the first web site (SP₁). The user is now logged in at SP₁ but not at SP₂.

At 222, the customer accesses SP₂ 105. The customer clicks on the link for SP₂ and their browser sends an HTTP request to the URL of SP₂ to get the requested page. Since the application of SP₂ doesn't have a valid login session for the customer, SP₂ redirects the customer back to the IDP at the URL of the IDP provider at 224. Information is encoded on the redirecting URL to tell the IDP that this is an authentication request from SP₂. At 226, the browser sees the web page for the IDP performing an authorization request. At 228, the IDP sees that the customer has a valid session and redirects the customer back to the application of SP₂. At 230, UC/EMS (SP₂) sees that the customer has been redirected to them from the IDP. The service does not yet have a valid session for them. SP₂ decodes the encoded URL information. Behind the scenes, SP₂ opens a back channel 232 to the IDP to validate the end-user. The IDP then validates the end-user (234). At 240, having validated the user, SP₂ sends the landing page for this specific customer.

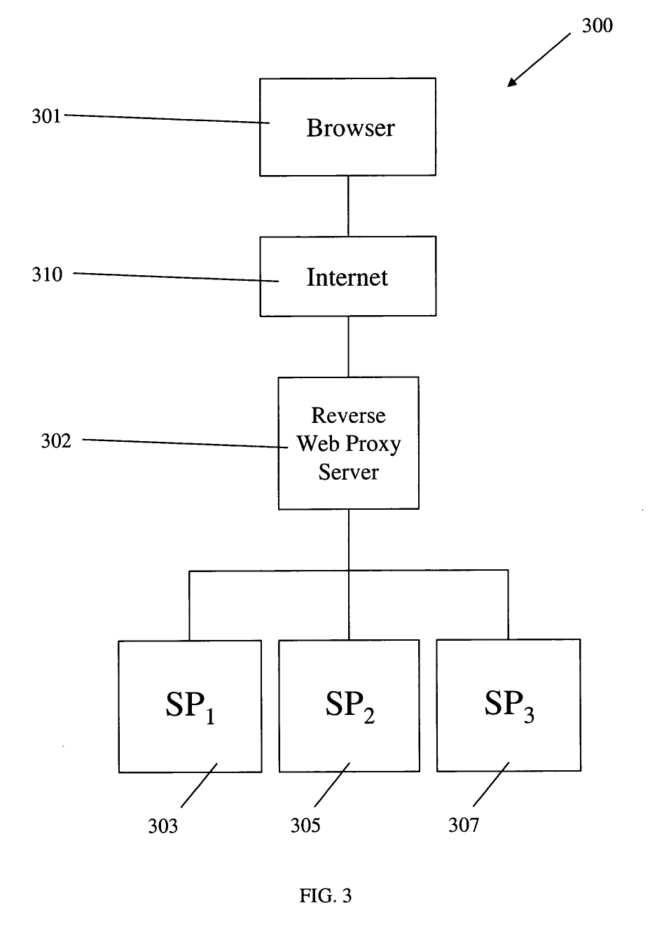

FIG. 3 illustrates another common Single Sign-On (SSO) model 300 referred to as the web trust model. Instead of having an IDP connected in parallel with the service providers as in the Federated Identity model, the web trust model uses a Reverse Web Proxy Server 302 to manage authentication and to serve as a front end to web servers (SP₁ 303, SP₂ 305, and SP₃ 307) running the service applications. The Reverse Web Proxy Server (RWPS) thus represents an enforcement point. In the web trust model, all customer browser 301 access occurs by literally passing through the RWPS 302 via the Internet 310. Service Providers interact through the RWPS and the RWPS is responsible for authenticating customers before passing their web page request on to the underlying applications.

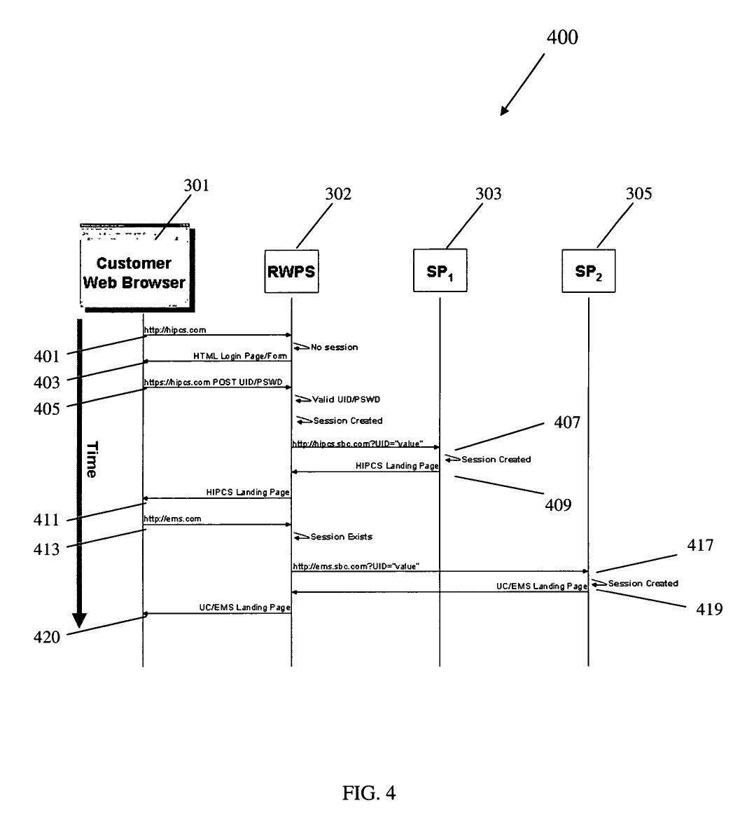

FIG. 4 illustrates a ladder diagram 400 displaying a time sequence of events that occur when a customer accesses a web-based application. At 401, an end-user directs browser 301 to an application of SP₁ 303. Since the URL of SP₁ really points to the Reverse Web Proxy Server (RWPS) 302, the browser sends the request to the RWPS and not directly to the application of SP₁. At 403, the RWPS examines the incoming HTTP request and determines that there is no current login session for this customer. At 403, the RWPS sends the browser 301 a login page or login form. The end-user fills in the login form and submits it. The form is posted to the RWPS. At 405, the RWPS validates the login information against either an internal or external database. The RWPS then creates a login session for the customer at SP₁. At 407, the RWPS forwards the request to SP₁ and encodes the customers username (UID) in the HTTP request. Note that the username that the RWPS passes on to the SP₁ may or may not be the same username the end-user used to login with. Often it is, but it does not have to be that way. At 409, the service of SP₁ takes the encoded HTTP request, sees that it is for a new session with an associated specific end-user. SP₁ then creates a new session for this customer. At 409, the SP₁ web application responds to the RWPS with the landing page for SP₁ for this specific end-user. At 411, the RWPS forwards the landing page response from SP₁ back to the end-user's web browser. The user is now logged in at SP₁ but not at SP₂.

The user now proceeds to access SP₂ 305. At 413, the end-user clicks on a link to the application of SP₂ sitting behind the RWPS. The browser sends this HTTP request to the URL of SP₂. This address is also on the RWPS. At 412, the RWPS receives the request for the SP₂ and checks to see if the customer has a valid login session already on SP₂. Since the session exists, at 417, the RWPS forwards the HTTP request on to the web application of SP₂ with the end-user's username encoded in the URL. Again, often the username the end-user uses to login in with will be the username passed between the RWPS and SP₂. However, the username may be a different value. The web application of SP₂ decodes the URL, sees that this is for a new session, and associates the passed username with the new session. At 419, the SP₂ web application responds to the HTTP request from the RWPS with the landing page of SP₂ for this specific end-user. At 420, the RWPS forwards the EMS landing page back to the end-user's web browser.

The web trust model is generally a simpler model than the Federated Identity model. However, the web trust model does not support authentication across security domains, wherein the federated identity model does. The web trust model also does not have an open standard protocol defining the relationship between the RWPS and that results in a potential lack of interoperability and multiple vendor implementations. Since all web traffic must traverse the RWPS, the web model doesn't lend itself to situations where the applications are run in different data centers by different operations staffs.

While the web trust model works great for many design situations, it doesn't support federation across different security domains. In general, Single Sign-On (SSO) can be implemented using either the web trust model and the federated identity model for implementing Single Sign-On.

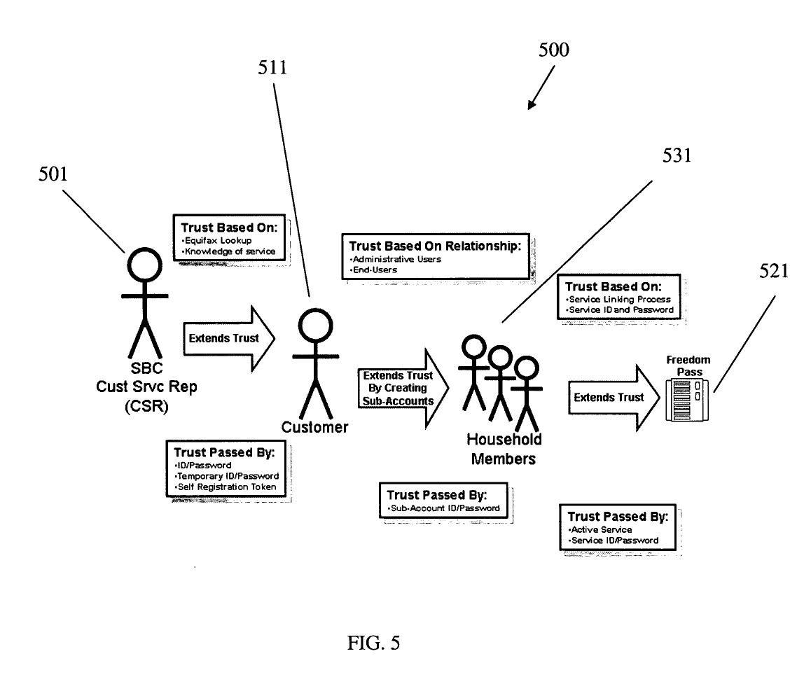

The present invention performs SSO by binding user credentials to a Single Sign-on (SSO) application account (SSO account). FIG. 5 illustrates an exemplary model 500 for extending trust to a SSO account in accordance with the present invention. A novel aspect of the present invention is the manner in which trust is extended from one entity to another. In prior art methods, for instance, trust is generally extended from a Service Provider to an Identity Provider. In the present invention, the user extends trust to a SSO account.

As a first step, trust is extended from the Service to the customer. During the service sales process, the Customer Service Representative (CSR) 501 talks to the customer 511. The customer provides personal information, such as a Social Security Number (SSN) or other credit related information, that can be compared to an external credit reporting agency, such as Equifax, for example. At the time the sale is closed, the CSR provides the customer with temporary access credentials needed to perform a first time account access and activation on the service.

Once the customer has activated the service and selected a username and password for the service, the customer can then link the service account to the SSO application 521 account. The user links the account by passing their access credentials for the service to application. After the account is linked, an SSO account is created and the SSO application can provide the customer with Single Sign-On (SSO) services.

Alternatively, the service allows customers to create sub-accounts, such as SSO accounts for family members 531. The trust is generally extended based on family relationship and is extended by supplying a sub-account username (or user ID) and password to the family member. The household members then get their service access credentials from the original customer. The SSO sub-account customers can use the credentials to link their personal SSO account to their service sub-account.

Enrollment in the SSO account can be done, for instance, anonymously over the Internet. An end-user can go an application website and register for an SSO account. However, the existence of an account does not grant the end-user any access to services. In order to use the SSO account with services, the service accounts are associated or linked to the account of the trusted application. The linking process enables the end-user to provide a valid login credentials for each application or service they wish to associate with the application.

The binding process describes the process of associating end-user SP accounts on different service providers and systems with each other. The binding process if often referred to as linking accounts. Different systems have different ways of identifying end-users and often the end-user's identity on a particular system is deeply tied to end-user service data and how the underlying service functions.

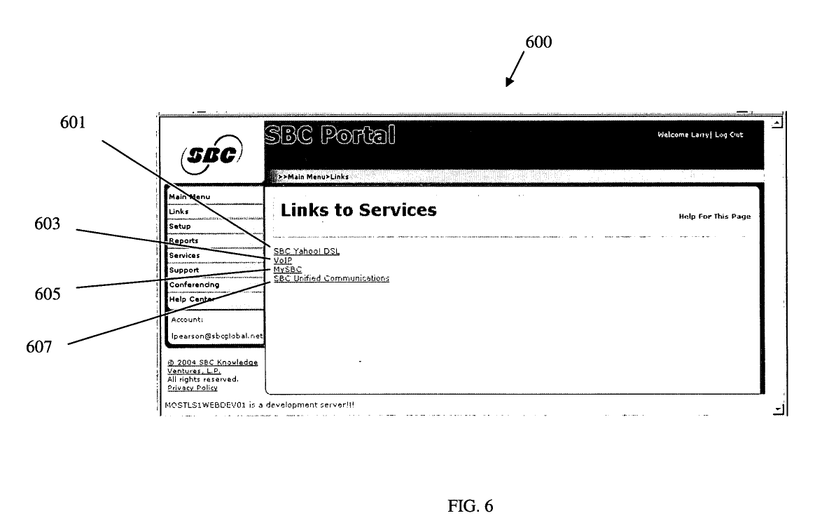

The present invention associates one or more of these SP accounts with a Single Sign-On (SSO) account. The existence of the associations or links are made visible to services so that any of the services can display a dynamic portal view on external systems of HTML links to associated or linked accounts linked with the SSO account. This is illustrated in the web page view 600 of FIG. 6 with links 601, 603, 605, and 607.

The Forced association model for linking accounts is available in the prior art. In the forced association model, an end-user service account is linked to their Single Sign-On (SSO) account during the order processing or provisioning phase.

In forced association, at the point of sale, the customer's Single Sign-On (SSO) account is associated with the order for new service. As the order flows through the provisioning systems, the necessary information to link the SSO account between the Identity Provider (IDP) and the Service Provider (SP) is provided on both the IDP and the SP. This linking is done at the same time service is activated on the SP. When an order is generated to cancel or delete service, a de-provisioning process occurs which destroys the linkage between the Identity Provider (IDP) and the Service Provider (SP). De-provisioning occurs as the SP account is deleted. In the forced association model, delegated administration capabilities must be extended to customers to allow the creation of sub-accounts.

The present invention provides for opt-in association of SP accounts with an SSO account. In the opt-in association model, end-users manually select to link their SP accounts to their SSO account by providing login information for each of their applications/services to the IDP. Opt-in association is voluntary. Customers receive access credentials for new services. When the customer chooses to create and use a Single Sign-On (SSO) account, they access the Identity Provider (IDP) portal site to initiate the manual account linking process. Accounts are linked by the customer logging into the portal, selecting “Link Accounts,” identifying the Service Provider (SP) to link to, and supplying the portal with access credentials for the account on the SP. This model works well where accounts are already created and/or there is no automated way to associate accounts with individual services to the Single Sign-On (SSO) account. An application integrated with the SSO account generation application or a separate application, such as an Account Management System, can be used to perform the linking and de-linking processes.

Opt-in (dynamic) association enables end-users to manually create and delete associations between their service accounts and their Single Sign-On (SSO) account.

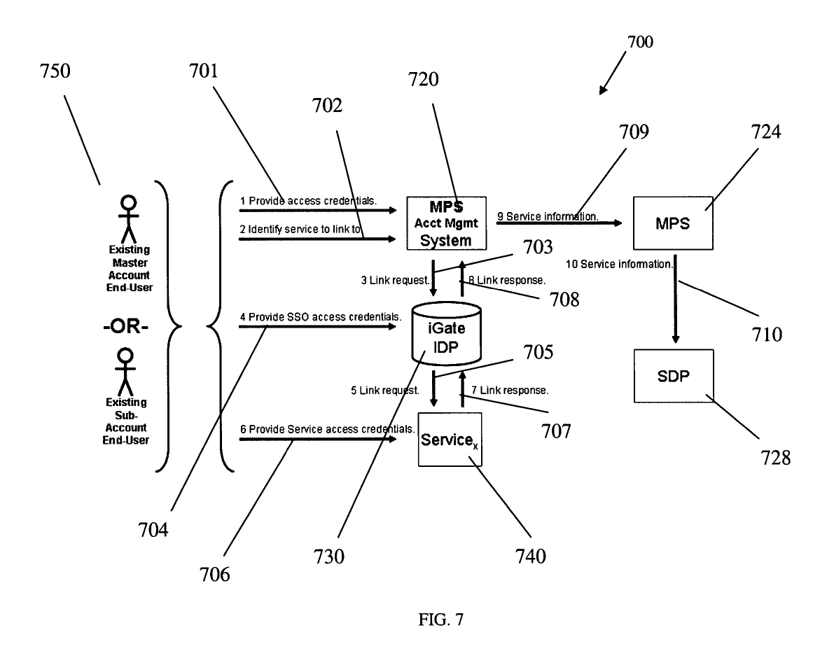

FIG. 7 shows a diagram 700 illustrating a method and apparatus for end-users to link their SSO account to an application or service (SP) that supports opt-in registration. Opt-in flows are determined by the Single Sign-On (SSO) technology. The figure provides information regarding the user experience and the integration points.

At 701 the end-user logs into the Account Management System 720. This can be done directly or through Single Sign-On (SSO). The Account Management System provides opt-in association web pages that provide a list of potential services (SPs) that an end-user can link to their SSO account. At 702, the end-user 750 selects the application with which they want to link accounts. Then, at 703, the Account Management System signals the Identity Provider 730 to link accounts with a specific service or application. To be consistent with Federated Identity Management (IdM) design patterns, the IDP can drive account linking. At 704, the end-user re-authenticates with the IDP. At 705, the IDP signals the service 740 of its intent to link accounts. At 706, the end-user provides their service specific authentication credentials to the SP. At 707, the service signals back to the IDP that account linking was successful. At 708, the IDP notifies the MPS Account Management System that linking was successful. Additional service related information can be supplied as well. At 709, the Account Management System provides the Member Profile System (MPS) 724 with service information relevant to the newly created link. The MPS comprises a database of associated links. The MPS 724 adds the service information to its list of valid links. At 710, the Account Management System provides SDP 728 with service information so that future automated provisioning actions can utilize the service information. SDP is a workflow engine with interface modules to a number of databases, directories, applications etc.

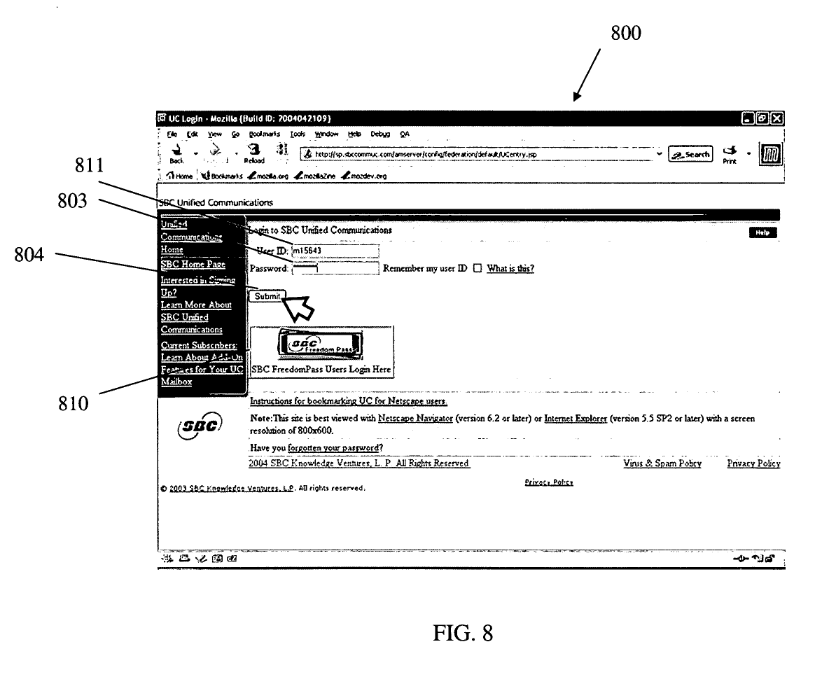

FIGS. 8-14 illustrates a user view of the operations of enabling SSO login, linking and de-linking of services from an SSO application. A SSO account enables Single Sign-On opt-in access to federated services. These services can be dynamically linked to the SSO application. When an end-user wants to access a service with the SSO account, they associate their SSO account with the service by supplying login credentials, such as a username and password. The process of associating accounts with the SSO account is referred to as linking. Disassociating accounts from the SSO account is referred to as de-linking. Once a participating application account has been linked to SSO account, the SSO account portal displays an application summary on the portal screen. Application summaries are typically displayed in small boxes on the portal screen. These small boxes are often referred to as portlets.

FIG. 8 illustrates a web page for a single service (SP) through which a user can perform a local login. The page comprises a textbox for entering a username (user ID) 801, a textbox for entering a password 803, and a submit button 804. A user logging in by using the text box is logged into the local service. The end-user enters their login information and selects “Submit” (804) to login to UC locally. Alternatively, if the user has a SSO account, the user can chose to login through SSO at this web site using the icon 810, thereby performing a SSO login.

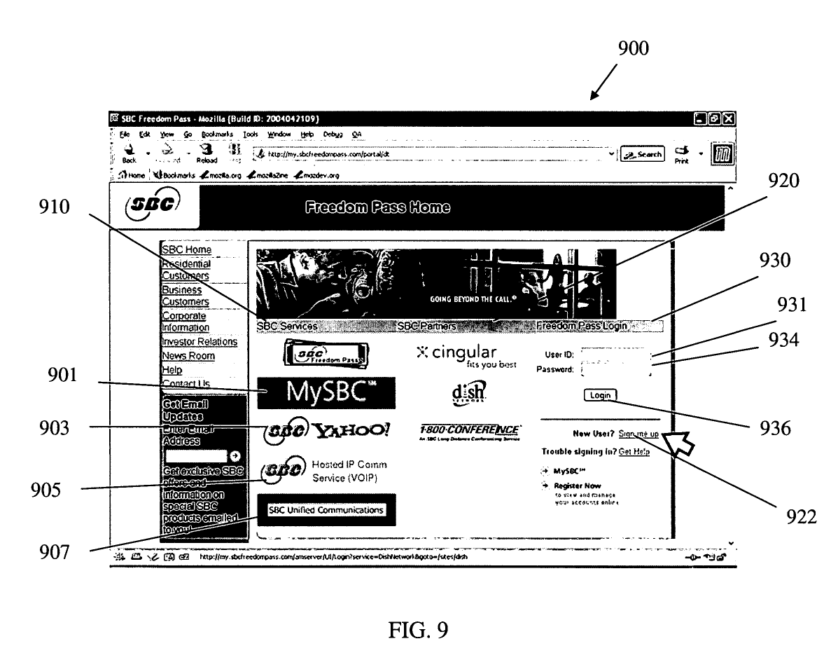

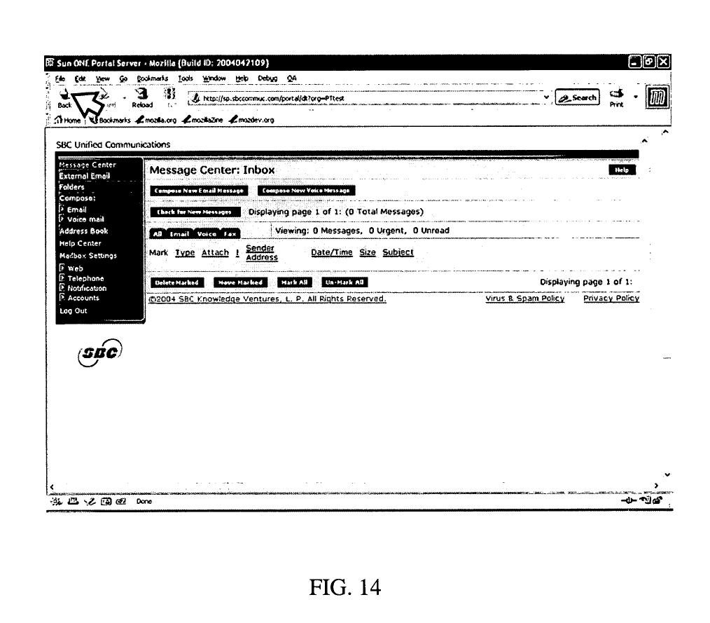

FIG. 9 illustrates a typical web portal login page 900 dynamically generated by the present invention. FIG. 9 displays a menu of services 910 within the federation as well as business partners 920 that can be associated with the SSO application. The menu 910 comprises links to various SPs, e.g., MySBC 901, SBC/Yahoo 903, HIPCS 905 and SBC UC 907. The links shown in FIG. 9 are for illustrative purposes, and any number of combination of links can be used. Also shown is an area for login to the SSO application, comprising textboxes for username (or user ID) 931 and Password 934, as well as a Login button 936. The user can create an SSO account by clicking on the “Sign me up” hyperlink 922. When the end-user clicks on one of the icons shown in 910 or 920, their web browser is transferred to the associated applications. Users only see this page (FIG. 9) if they are not already logged into the SSO application. If they are already logged into the SSO application, consistent with the SSO model, they are dropped into the SSO application landing page (FIG. 14).

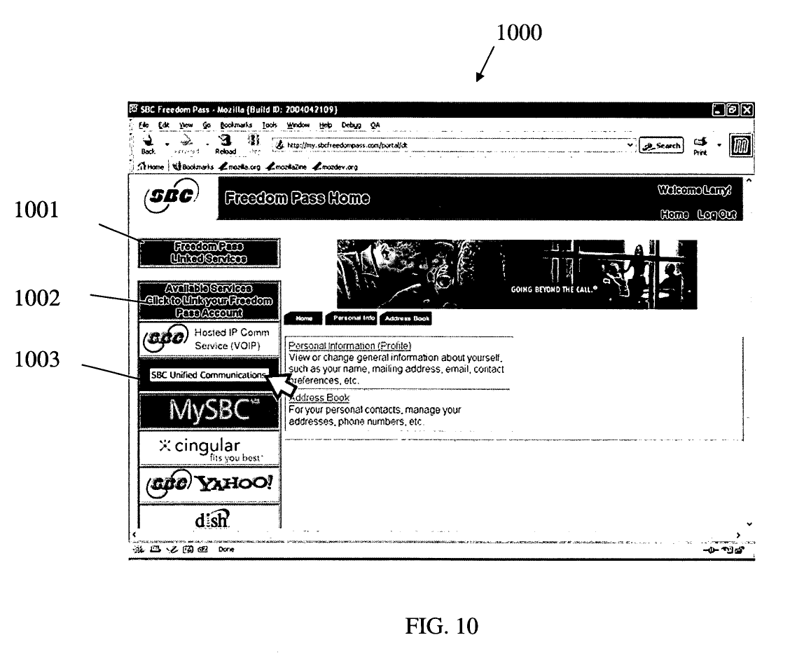

FIG. 10 illustrates an exemplary landing page associated with the SSO application. On the left hand side of the screen, the panel lists two menus of services. The first menu 1001 comprises the services currently linked to an SSO account. Since no services are currently linked, menu 1001 is empty. The second menu 1002 shows services that are available for linking to the SSO application. In order to link a service, the end-user clicks on the icon associated with the service. In the example of FIG. 10, the end-user has chosen to link Unified Communication application and thus clicks on icon 1003 to begin the linking process.

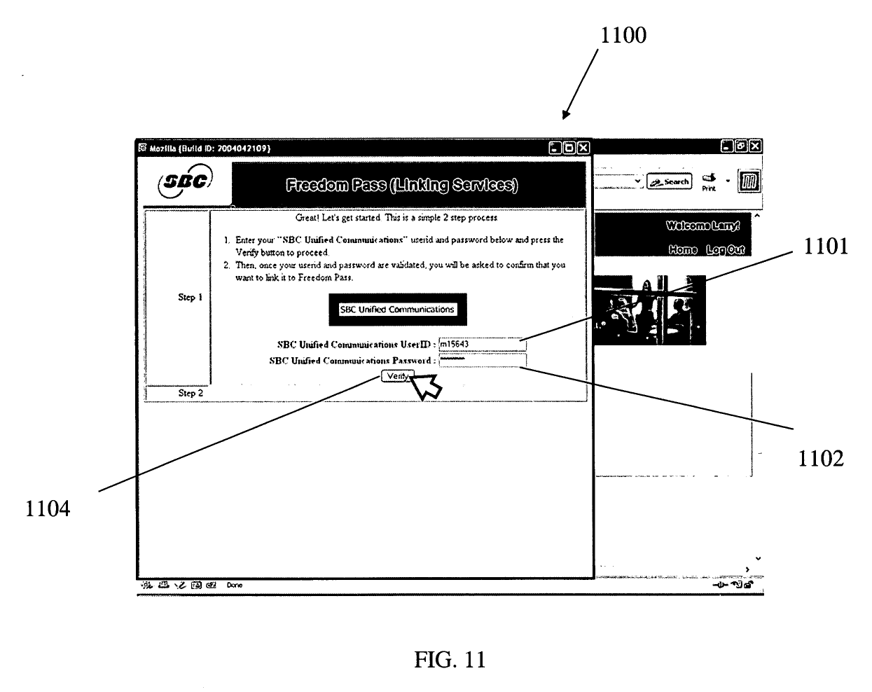

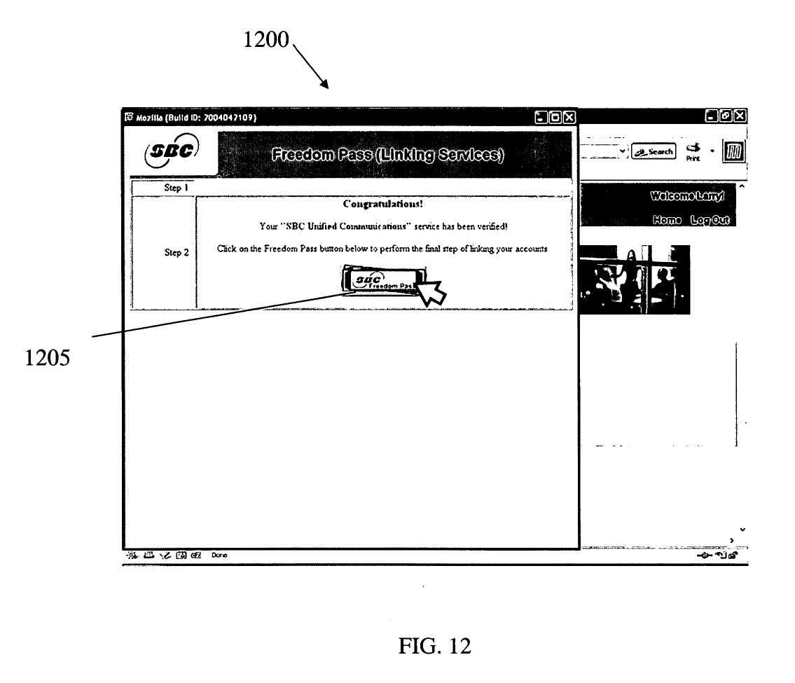

FIG. 11 illustrates a portal view 1100 for linking to the service chosen in FIG. 10. After confirming their desire to link an application, the end-user next provides their local login credentials (i.e., username (or user ID) 1101 and password 1102) for the system to be linked and clicks on “Verify” 1104 to submit. FIG. 12 illustrates a web view 1200 showing the linking process. The end-user clicks on the icon 1205 to complete linking and returns to the portal web page.

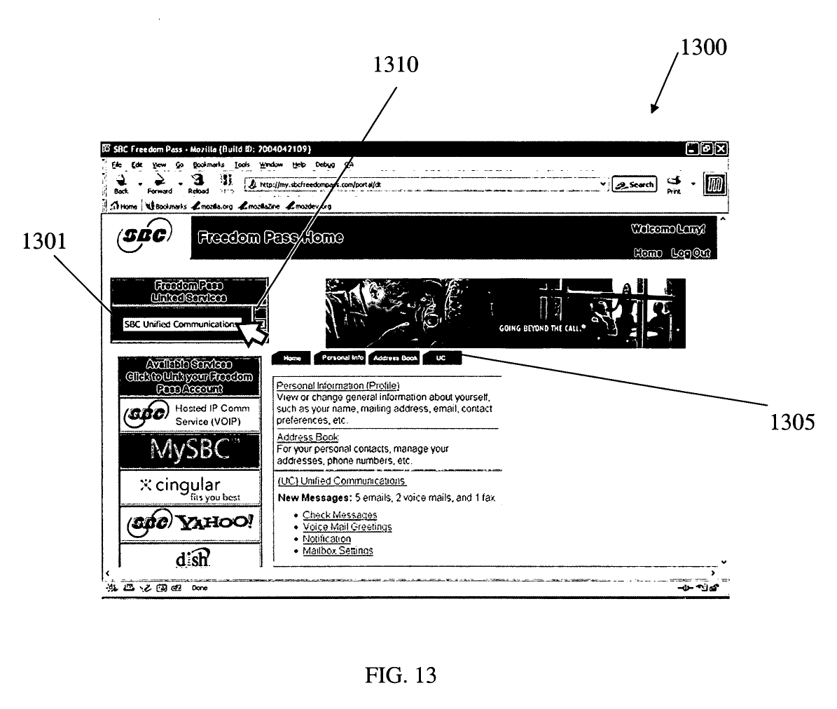

FIG. 13 illustrates a portal view 1300 of the SSO application, once the service (i.e., Unified Communications) has been linked to the application. The portal landing page automatically reconfigures and displays an icon 1301 corresponding to the service in the menu for linked services. A tab 1305 is also displayed corresponding to the linked service. The service can be unlinked by clicking the “X” 1310 displayed to the right of the icon 1301 in the menu of linked services. When the end-user clicks on icon 1301, they are taken to the corresponding landing page (FIG. 14).

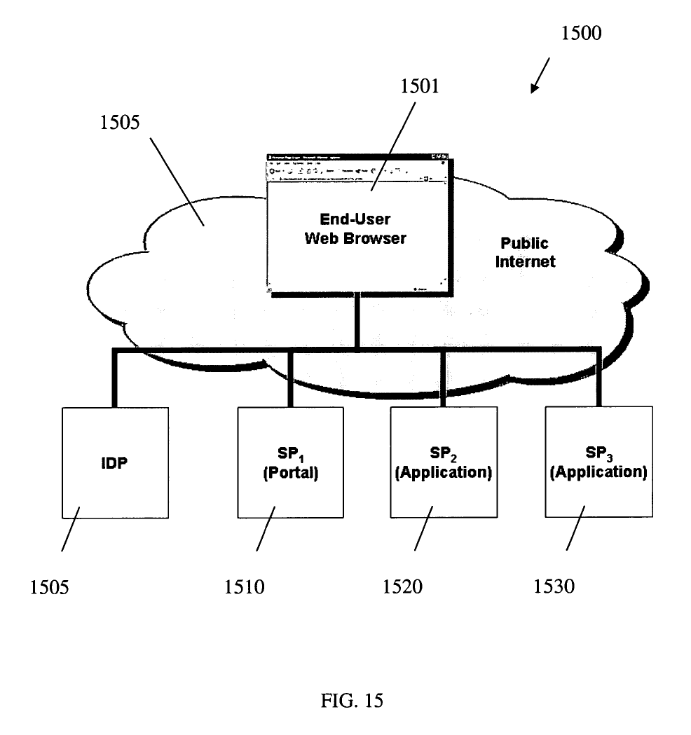

FIG. 15 illustrates a system 1500 comprising a portal for initiating a federated Single Sign-On account which links between an Identity Provider (IDP) and any Service Provider (SP). The invention comprises an End-User Web Browser 1501, an IDP 1505, portal SP1 1510, application SP₂ 1520 and application SP₃ 1530. Each element represents a node on the Internet with a specific type or role. The end-user uses a web browser connected to the Internet to access these services/applications. The IDP is a federated Identity Provider that follows one of the federated identity protocols such as Liberty ID-FF, OASIS WS-Federation, or OASIS SAML 2.0. In an exemplary embodiment, the Liberty ID-FF protocol is used, but any of the others would be applicable as well. In the federated identity model, portals, such as SP₁, are a type of service provider. That is, the portal is considered to be a Service Provider by the IDP.

To illustrate the present invention, the target application or service being linked is SP₂. The service being linked can be any generic application or service accessible through the Internet that has been integrated with the Portal (SP₁) and the IDP. The inclusion of application SP₃ illustrates that this approach is generic and can be used with any Service Provider. The number of applications shown is for illustrative purposes only and any number of applications can be accommodated.

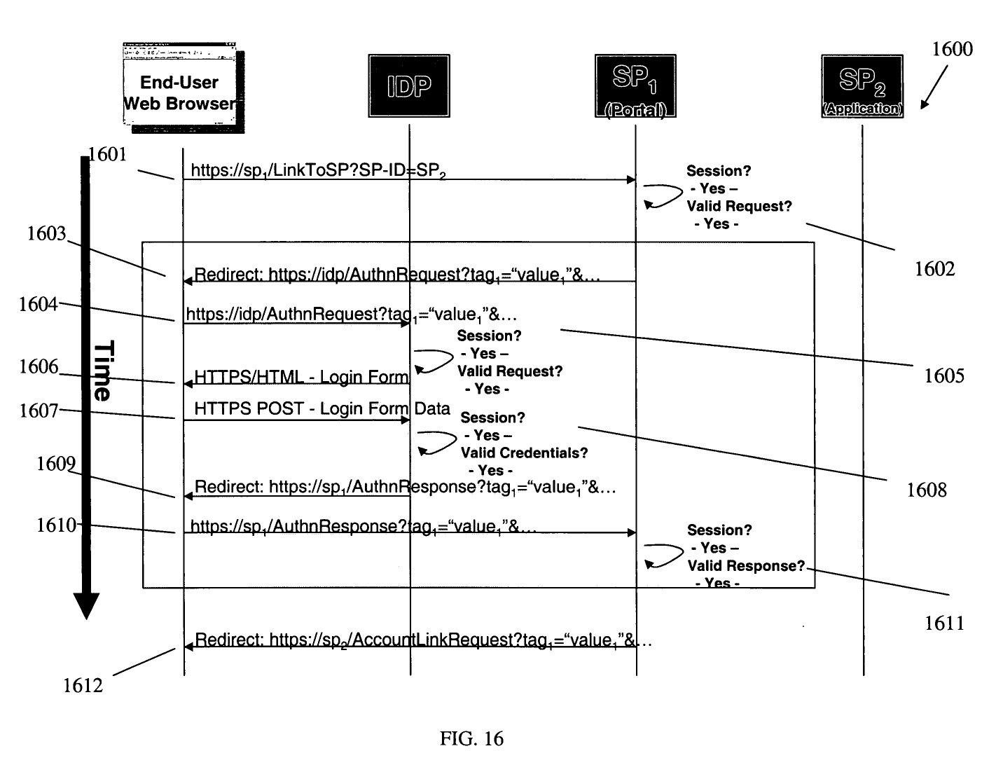

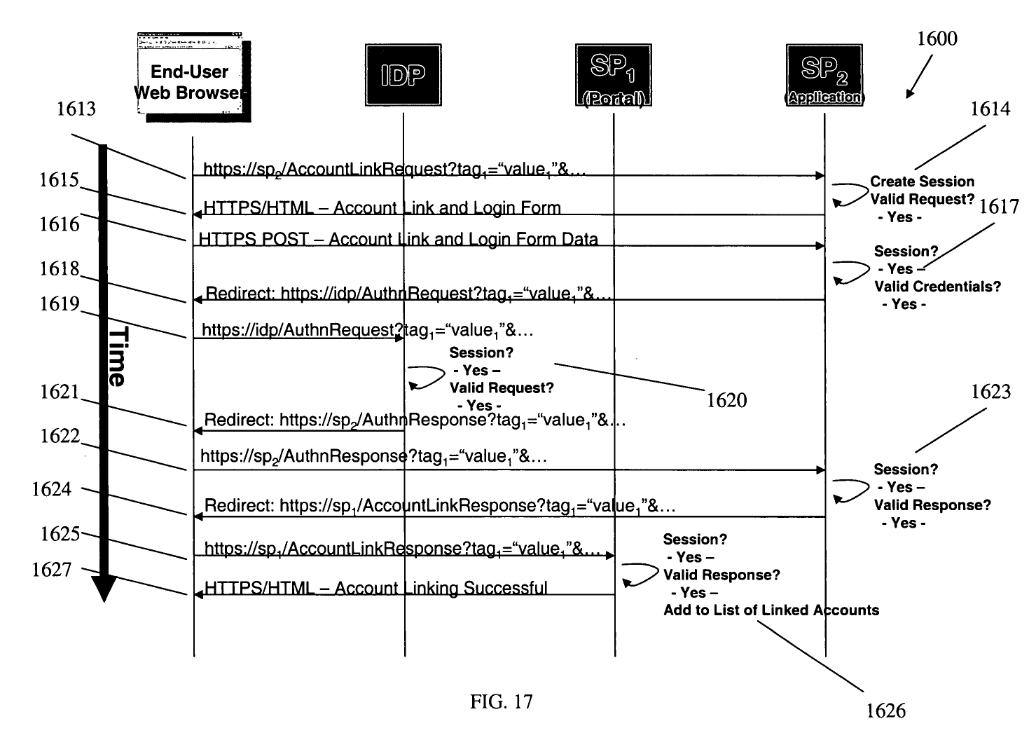

FIGS. 16 and 17 illustrate a ladder diagram 1600 illustrating steps for logging in and using the SSO method of the present invention. The ladder diagram shows the time sequence of events supporting portal initiated account linking. In Step 1601, the portal (SP1) 1510 interacts with the end-user's browser 1501 to signal that it is time to link a specific service with the SSO account. Although there are a number of ways for portal and browser to interact, the method outlined herein uses data encoded in the URL (e.g., GET form method). A form POST method is also valid.

In Step 1602, the portal checks to see if the current request can be associated with a valid end-user session. Since the request can be associated with an end-user session, the portal then decodes the form data (the encoded URL) and sees that the request is to link the currently active SSO account with the service application account on SP₂ 1520.

Steps 1603 through 1611 illustrate a typical method and interaction for authentication between Service Provider (SP) to Identity Provider (IDP), except that the portal sets a value in the Authentication Request forcing the IDP to re-authenticate. In Step 1603, to guard against unintentional account linking by third parties, the present invention enables the IDP to re-authenticate the end-user. The portal simply requests a re-authentication from the IDP.

In Step 1612, portal SP₁ signals SP₂ that the end-user is requesting to link accounts by using the redirect method with information encoded on the URL. The URL encoding includes: a link request (accountLinkRequest), an IDP identifier, a SP identifier, a redirect URL, a TIMESTAMP, and a CHECKSUM. The accountLinkRequest is a request type sent from the portal to the SP₂. An IDP identifier (IDP-ID) uniquely identifies the IDP from all other IDPs, and the SP identifier (SP-ID) is the portal's identifier. The portal is another Service Provider, and generalizing the protocol exchange in this way enables generic implementation. Therefore, any SP can have a portal role. The redirect URL is the URL that the portal wants to receive the link account response back on. Timestamps are used to secure the system against replay attacks. For example, if the receiving party doesn't receive the response within the timeout period, then the request is considered invalid. Check sums are used to ensure that the contents of the encoded URL haven't been changed. Checksums also make replay attacks more difficult. The URL encoded data may be encrypted using encryption keys and methods that are known by both SP₁ and SP₂.

In Step 1613, the browser passes the encoded URL created in step 1612 to SP₂. In Step 1614, SP₂ creates a session for this browser enabling session tracking for subsequent browser interactions with this specific end-user. SP₂ decodes the encoded URL and validates the information provided. The encoded URL indicates that this request is for linking accounts.

In Step 1615, SP₂ sends the end-user a link activation form. This form may have multiple functions, such as Authentication, Terms and Conditions, and Incentives, for example. In order to authenticate, the form requires that the end-user enter their username and password for this specific application. A single web page can be used with all of the necessary form elements, or a web designer may decide to split this form into multiple web pages with multiple steps.

In Step 1616, the end-user completes and submits the form from step 1615. In Step 1617, SP₂ associates the end-user with the correct web session, and then validates the information supplied in the form. Minimally, SP₂ will validate the username and password against its internal database or directory of end-user accounts.

In Step 1618, SP₂ creates an encoded URL authentication and account linking request for IDP using the Liberty Single Sign-On and Federation Profile. This request is the same as an Authentication Request except that SP₂ is also requesting federation with the end-user's SSO account. The encoded URL is sent as a redirect message to the browser for forwarding to the IDP.

In Step 1619, the browser forwards the authentication and federation request from SP₂ to the IDP. In Step 1620, the IDP checks to see if the end-user has a valid SSO session and then checks to see if the request is a valid request. The IDP decodes the message into its component parts and sees that this is an authentication and federation request. The IDP creates the data structures and entries in its own database and directory necessary for federating the SSO account with the account on SP₂.

In Step 1621, the IDP crafts the authentication and federation request response and sends it back to the browser as a redirect of an encoded URL destined for SP₂. In Step 1622, the browser forwards the authentication and federation response to SP₂. In Step 1623, SP₂ associates the specific end-user with the correct session. Next, SP₂ decodes the authentication response from the IDP and builds the appropriate data structures in its own database or directory.

Once the account linking has successfully completed, SP₂ creates an encoded URL to send back to the portal (Step 1624). The encoded URL contains fields that contain information, such as an account link response (AccountLinkResponse), TIMESTAMP and CHECK-SUM, used by the portal to process the link request response.

In Step 1625, the browser forwards the account linking response from SP₂ to the portal. In Step 1626, the portal associates this specific end-user with a session. The URL is decoded, and the decoded information is validated. SP₂ is added to the list of valid account linkages maintained by the portal. The list is stored in a permanent database or directory. In Step 1627, the portal sends a web page back to the end-user telling the end-user that the accounts have been successfully linked.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A computerized method for linking a single sign-on (SSO) account with a service comprising:
establishing a SSO account;
accepting a user selection for a service to link with the SSO account; and
linking the selected service to link with the SSO account.

2. The method of claim 1, further comprising:
generating a view of services linked with the SSO account from a service.

3. The method of claim 2, wherein the view is generated from any service linked with the SSO account.

4. The method of claim 1, further comprising:
accepting a user selection for a service to de-link from the SSO account; and
de-linking the selected service to de-link with the SSO account.

5. The method of claim 2, wherein the view comprises a web page.

6. A computer readable medium containing instructions that when executed by a computer perform a method for linking a single sign-on (SSO) account with a service comprising:
establishing a SSO account;
accepting a user selection for a service to link with the SSO account; and
linking the selected service to link with the SSO account.

7. The medium of claim 6, the method further comprising:
generating a view of services linked with the SSO account from a service.

8. The medium of claim 7, wherein in the method the view is generated from any service linked with the SSO account.

9. The medium of claim 6, the method further comprising:
accepting a user selection for a service to de-link from the SSO account; and
de-linking the selected service to de-link with the SSO account.

10. The medium of claim 7, wherein in the method the view comprises a web page.

11. A set of application program interfaces embodied on a computer readable medium for execution on a computer in conjunction with an application program that links a single sign-on (SSO) account with a service comprising:
a first interface that receives a user input for establishing a SSO account;
a second interface that receives a user selection for a service to link with the SSO account, wherein the application program links the selected service to link with the SSO account.

12. The set of application program interfaces of claim 11, wherein the application program generates a view of services linked with the SSO account from a service.

13. The set of application program interfaces of claim 12, wherein the view is generated from any service linked with the SSO account.

14. The set of application program interfaces of claim 11, further comprising:
a third application program interface for accepting a user selection for a service to de-link from the SSO account, wherein the application program de-links the selected service from the SSO account.

15. The set of application program interfaces of claim 12, wherein the view comprises a web page.
